(19) United States
(12) Patent Application Publication
(10) Pub. No.: US 2013/0141639 A1
(43) Pub. Date: Jun. 6, 2013

(54) CAMERA MODULE AND MOBILE COMMUNICATION TERMINAL INCLUDING THE SAME

(71) Applicant: Pantech Co., Ltd., Seoul (KR)

(72) Inventors: Hong-Kyu KIM, Seoul (KR); Sung-Pil KIM, Seoul (KR)

(73) Assignee: PANTECH CO., LTD., Seoul (KR)

(21) Appl. No.: 13/687,264

(22) Filed: Nov. 28, 2012

(30) Foreign Application Priority Data
Dec. 1, 2011 (KR) 10-2011-0127903

(51) Int. Cl. H04N 5/225

(52) U.S. Cl. CPC H04N 5/2254
USPC 348/374

(57) ABSTRACT

A camera module including an optical tube including a lens, a photodetector disposed on a first portion of a substrate, and multiple capacitors disposed on a second portion of the substrate, in which the lens overlaps only the first portion of the substrate among the first portion and the second portion of the substrate. A mobile terminal including an optical tube including a lens, a photodetector disposed on a first portion of a substrate, and a plurality of capacitors disposed on a second portion of the substrate, a bezel unit to overlap a portion of the camera module, in which the lens overlaps only the first portion of the substrate among the first portion and the second portion of the substrate, and the first portion of the substrate is disposed towards an edge portion of the mobile terminal.

### CROSS-REFERENCE TO RELATED APPLICATION

This application claims priority from and the benefit under 35 U.S.C. §119(a) of Korean Patent Application No. 10-2011-0127903, filed on Dec. 1, 2011, in the Korean Intellectual Property Office, which is incorporated herein by reference for all purposes.

### BACKGROUND

1. Field

The following description relates to a camera module, and more particularly, to a camera module to capture an image of an object and a mobile communication terminal including the camera module.

2. Discussion of the Background

A camera module is a device to convert external optical information into electrical signals. The camera module may be mounted in a mobile device, such as a mobile phone, a smartphone, an MP3 player and the like. The camera module may be placed at the rear of a smartphone to capture images of objects or scenes or to support augmented reality (AR) operations. In addition, the camera module may be installed at the front side of the smartphone to enable video calling or to capture a self-portrait.

To accomplish the above operations, a general camera module may include an optical tube to support at least one lens and an image sensor to convert an incoming image through the optical tube into digital signals. In addition, active pixels of the image sensor generate electrical values that correspond to light energy radiated by an object.

With advancement of communication technologies, there is an increased demand for high resolution video calls. To enable high resolution video calls, an increase in the number of pixels of a front-facing smartphone camera module is prerequisite. Accordingly, camera modules with higher resolutions, such as 1.3 or 2.0 Megapixel, are increasingly used, instead of camera modules with lower resolutions, such as 0.3 Megapixel, which have been generally used.

FIG. 1 is a perspective view of a general mobile communication terminal equipped with a camera module. FIG. 2 is a front view of the mobile communication terminal shown in FIG. 1. FIG. 3 is a cross-sectional view of the mobile communication terminal taken along line P-P of FIG. 1.

Referring to FIG. 1, a mobile communication terminal 1 equipped with a camera module 11 includes a main board 13 disposed inside the mobile communication terminal 1, a display unit 120 placed at its front, and a bezel unit 10 surrounding the display unit 12. The display unit 12 includes a touch sensor 12a and a flat panel 12b. A part of the bezel unit 10 is includes a transparent portion 10a that may be made of a transparent material in an effort to capture images of an object, and the camera module 11 is placed in a space under the transparent portion 10a. The camera module 11 is coupled to a top surface of the main board 13.

Referring to FIG. 1, FIG. 2, and FIG. 3, as the number of pixels of the camera module 11 increases, the size of an image sensor (not shown) is also increased. Thus, if the camera module 11 including the image sensor is installed on the front face of the mobile communication terminal 1, the width of the bezel unit 10 surrounding the display unit 12 is bound to increase in response to the increased size of the image sensor.

In addition, the size of the display unit 12 may increase to provide larger image display and to enable easier navigation of information, such as Internet surfing, and there has been an increasing attempt to reduce the size of the bezel unit 10. However, the bezel unit 10 needs to reserve a certain amount of space for the camera module 11, a proximity sensor and speakers, and hence there is a limitation in reducing the size of the bezel unit 10. Moreover, due to the large-sized screen of the display unit 12 and the high-resolution camera module 11, the overall size of the mobile communication terminal 1 is bound to be increased, which may make it more difficult to grip, hold, carry or move the mobile communication terminal 1.

### SUMMARY

Exemplary embodiments of the present invention provide a camera module capable of reducing the width of a bezel unit, and a mobile communication terminal including the camera module.

Additional features of the invention will be set forth in the description which follows, and in part will be apparent from the description, or may be learned by practice of the is invention.

Exemplary embodiments of the present invention provide a camera module including an optical tube including a lens; a photodetector disposed on a first portion of a substrate; and a plurality of capacitors disposed on a second portion of the substrate, in which the lens overlaps only the first portion of the substrate among the first portion and the second portion of the substrate.

Exemplary embodiments of the present invention provide a terminal including a camera module having an optical tube including a lens, a photodetector disposed on a first portion of a substrate, and a plurality of capacitors disposed on a second portion of the substrate; a bezel unit to overlap the first portion of the substrate; and a display unit to overlap the second portion of the substrate.

Exemplary embodiments of the present invention provide a camera module in a mobile terminal including an optical tube including a lens; a photodetector disposed on a first portion of a substrate; and a plurality of capacitors disposed on a second portion of the substrate; a bezel unit to overlap a portion of the camera module, in which the lens overlaps only the first portion of the substrate among the first portion and the second portion of the substrate, and the first portion of the substrate is disposed towards an edge portion of the mobile terminal.

Exemplary embodiments of the present invention provide a camera module including an optical tube including a lens; a photodetector disposed on a first portion of a substrate; and a plurality of capacitors disposed on a second portion of the substrate, in which the lens is disposed to extend beyond one of the edges of the photodetector.

It is to be understood that both the foregoing general description and the following detailed description are exemplary and explanatory and are intended to provide further is explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view of a general mobile communication terminal equipped with a camera module.

FIG. 2 is a front view of the mobile communication terminal shown in FIG. 1.

FIG. 3 is a cross-sectional view of the mobile communication terminal taken along line P-P of FIG. 1.

FIG. 4 is a diagram illustrating a camera module according to an exemplary embodiment of the present invention.

FIG. 5 is a top view illustrating the camera module shown in FIG. 4.

FIG. 6, FIG. 7, and FIG. 8 are top views illustrating various arrangements of capacitors in the camera module shown in FIG. 5.

FIG. 9 is a top view illustrating a camera module according to an exemplary embodiment of the present invention.

FIG. 10 and FIG. 11 are front views illustrating mobile communication terminals equipped with a camera module according to an exemplary embodiment of the present invention.

FIG. 12 is a cross-sectional view of the mobile communication terminal taken is along line X-X of FIG. 10.

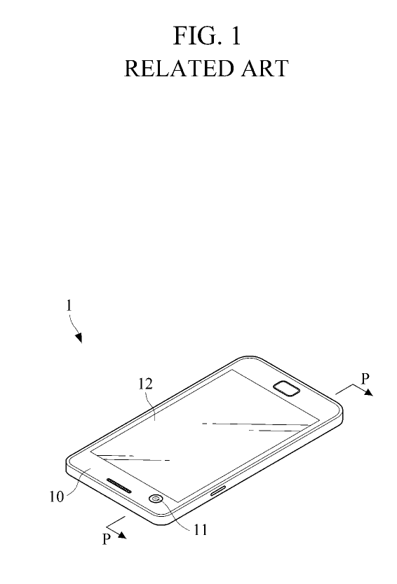

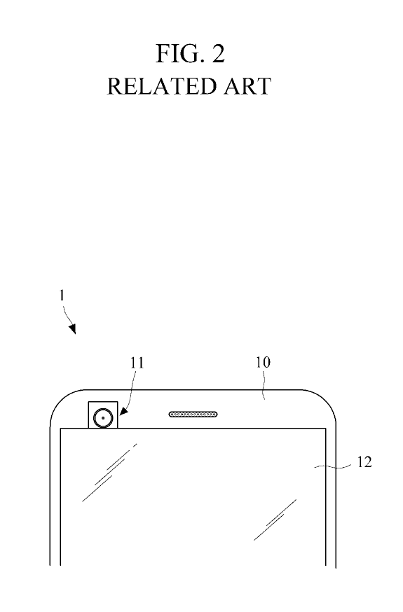

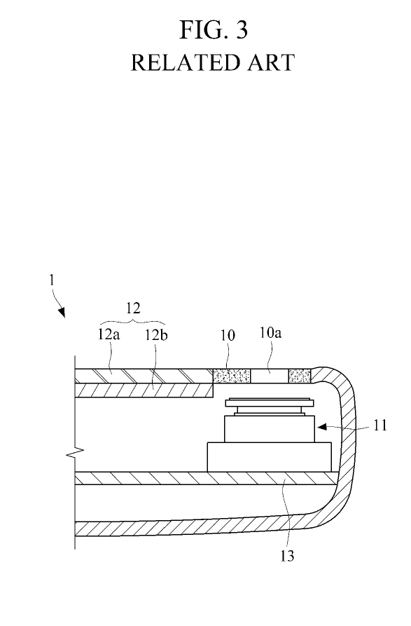

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that when an element is referred to as being “on” or “connected to” or “coupled to” another element, it can be directly on, directly connected to, or directly coupled to the other element, or intervening elements may be present. In contrast, if an element is referred to as being “directly on” or “directly connected to” or “directly coupled to” another element, no intervening elements are present. Further, it will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

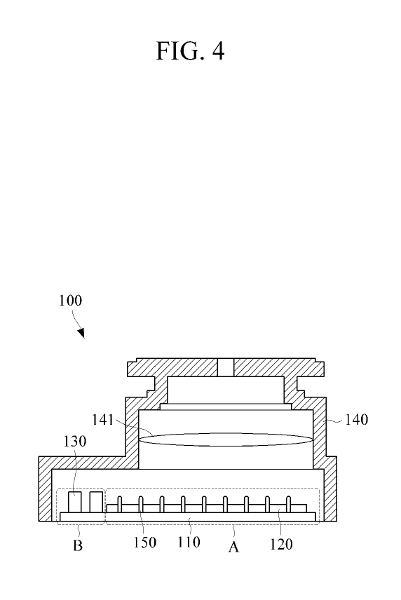

FIG. 4 is a diagram illustrating a camera module according to an exemplary embodiment of the present invention.

Referring to FIG. 4, the camera module 100 includes a substrate 110, a photodetector 120 (e.g., a photodiode), one or more capacitors 130, and an optical tube 140. The photodetector 120 may be connected to the substrate using wire bonding 150. Further, the optical tube 140 includes a lens 141 disposed therein.

The photodetector 120 and the capacitor 130 are disposed on the substrate 110. The substrate 110 may be, for example, rectangular. However, aspects of the invention are not limited thereto, such that the substrate 110 may be circular, triangular, and the like.

The photodetector 120 is placed eccentrically with respect to a central region or the center of the substrate 110, and may convert incoming light into electrons and store the electrons. The photodetector 120 may be electrically connected to the substrate 110 via wire is bonding 150. However, the connection between photodetector 120 and the substrate 110 may not be limited to wire bonding, and a lower part of the photodetector 120 may be electrically connected to the substrate 110.

The capacitor 130 may be mounted on the substrate 110, and be disposed within a reference proximity of the photodetector 120. The capacitor 130 may increase capacity of the photodetector 120. As shown in FIG. 4, the capacitor 130 may be placed close to or within a reference proximity to an edge of the photodetector 120. More specifically, the photodetector 120 may be placed in a first region A, and at least one capacitor 130 may be placed in a second region B.

As shown in FIG. 4, at least a portion of the first region A is overlapped by the lens 141, whereas the second region B does not. Further, the second region B may be disposed in an extended lower portion of the optical tube 140, in which the extended lower portion may extend towards central region of a mobile communication terminal. In addition, a first portion or a right portion of the optical tube 140 may extend to a smaller distance from a first edge of the lens 141, which contacts a side of the optical tube 140, than a second portion of the optical tube 140, which contacts another side of the optical tube 140. Accordingly, a distance from a side of the camera module 100, more particularly, the lower portion or base of the camera module 100, to an edge of the mobile communication terminal may be reduced.

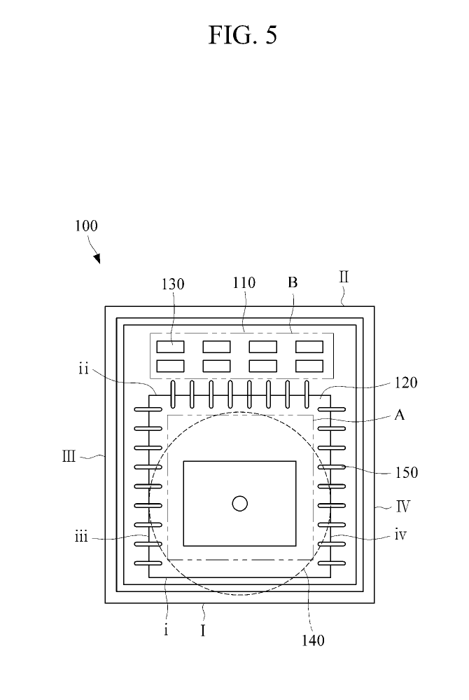

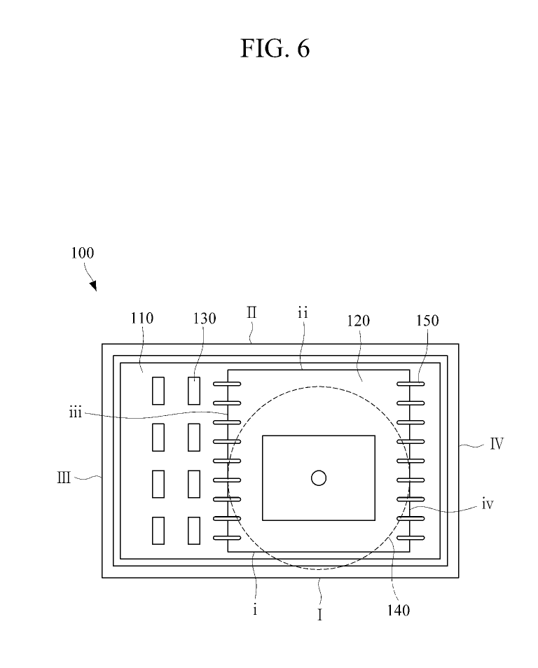

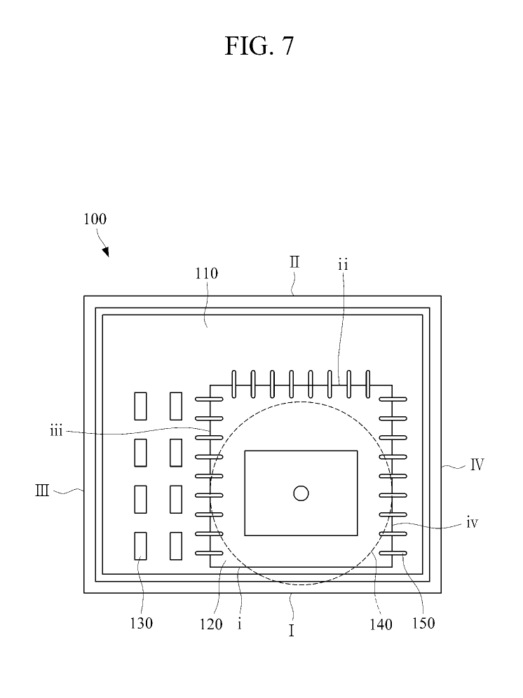

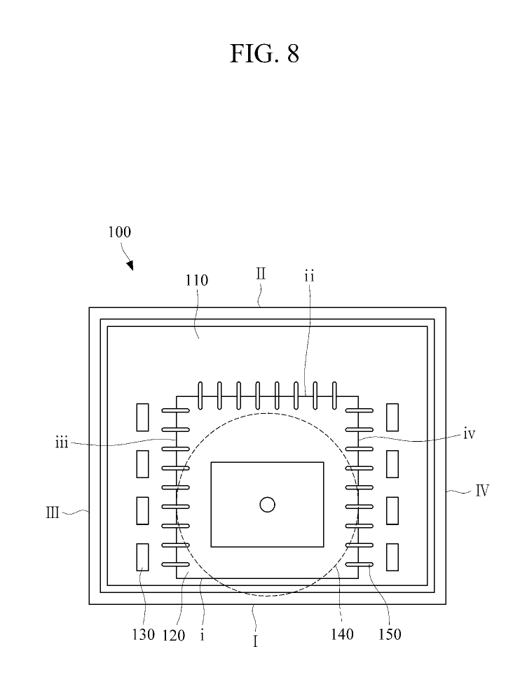

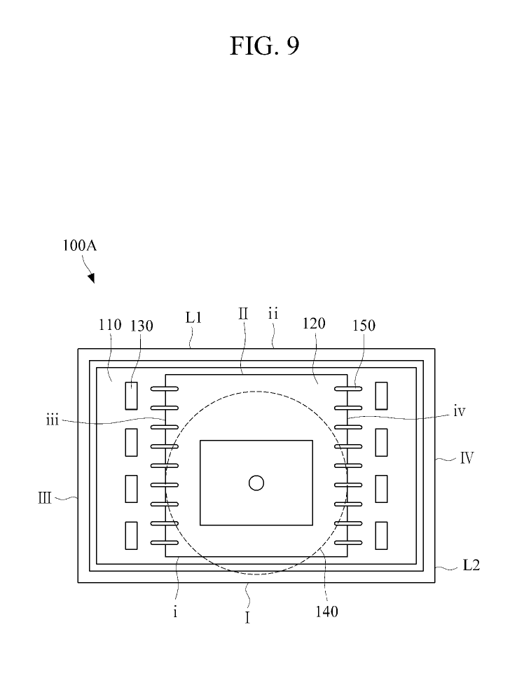

FIG. 5 is a top view illustrating the camera module shown in FIG. 4. FIG. 6, FIG. 7, and FIG. 8 are top views illustrating various arrangements of capacitors in the camera module shown in FIG. 5. FIG. 9 is a top view illustrating a camera module according to an exemplary embodiment of the present invention. Although FIG. 4 to FIG. 9 may be described with respect to a first edge/side referring to a bottom edge/side, a second edge/side referring to an upper is edge/side, a third edge/side referring to a left edge/side, and a fourth edge/side referring to a right edge/side, aspects of the invention are not limited thereto.

Referring to FIG. 5, the first edge/side and the second edge/side may refer to the edges/sides parallel with the shorter edges/sides of the camera module 100. The third edge/side and the fourth edge/side may refer to sides/edges parallel with the longer edges/sides of the camera module 100.

Referring to FIG. 6, FIG. 7, FIG. 8 and FIG. 9, the first edge/side and the second edge side may refer to edges/sides parallel with the longer edges/sides of the camera module 100. The third edge/side and the fourth edge/side may refer to sides/edges parallel with the shorter edges/sides of the camera module 100.

As shown in FIG. 5, the optical tube 140 is disposed to be closer to a first edge I of the camera module 100. Further, the optical tube 140 may be flush with or within a reference proximity of an edge of the camera module 100, such as the first edge I. The wire bonding 150 is provided on three sides of the photodetector 120 (i.e., a second side ii, third side iii, and a fourth side iv), but not on one side (i.e., a first side i), which may be the closest of the four sides to the first edge I of the camera module 100. Further, the lens 141 may be disposed such that a portion of the lens 141 extends beyond the first side i of the photodetector 120. The extended portion of the lens 141 may extend towards an edge of a mobile communication terminal housing the camera module 100. The plurality of capacitors 130 is disposed to be closer to a second edge II of the camera module 100.

In addition, as shown in FIG. 6 and FIG. 7, the wire bonding 150 on the substrate 110 may be implemented in various shapes and the plurality of capacitors 130 may be disposed at various locations. More specifically, referring to FIG. 6, the wire bonding 150 are provided on is two sides parallel to the shorter edges of the camera module 100 (i.e., a third side iii and a fourth side iv of the photodetector 120), but not on the other two sides parallel to the longer edges of the camera module 100 (i.e., a first side i and a second side ii of the photodetector 120). Further, the lens 141 may be disposed such that a portion of the lens 141 extends beyond the first side i of the photodetector 120. The extended portion of the lens 141 may extend towards an edge a mobile communication terminal housing the camera module 100. Further, the plurality of capacitors 130 is disposed on a third side III of the camera module 100.

Referring to FIG. 7, the wire bonding 150 are provided on three sides (i.e., the second side ii, third side iii, and fourth side iv), but not on one side (i.e., the first side i) of the photodetector 120. The first side of the photodetector 120 may be the closest of the four sides to the first edge I of the camera module 100. The plurality of capacitors 130 is disposed to be closer to a second edge II of the camera module 100. Further, camera module 100 of FIG. 7 may have a larger substrate 110 that may be disposed towards a second edge II of the camera module 100.

However, referring to FIG. 8, the capacitors 130 may be arranged or disposed on two sides of the photodetector 120 that are parallel to the shorter edges of the camera module 100 (i.e., the third side iii and fourth side iv). More specifically, at least one capacitor 130 may be positioned on the third side iii and the fourth side iv of the photodetector 120. However, aspects of the invention are not limited thereto, such that rows of capacitors 130 may be arranged to be perpendicular to one another. For example, a row of capacitors 130 may be disposed on the second side ii and another row of capacitors 130 may be disposed on the third side iii of the photodetector 120. Further, the wire bonding 150 are provided on three sides (i.e., the second side ii, third side iii, and fourth side iv) of the photodetector 120, but not on one side (i.e., the is first side i) of the photodetector 120. The first side i of the photodetector 120 may be the closest of the four sides to the edge of the camera module 100. Although not illustrated, wire bonding 150 may not be present on the sides of the photodetector 120 that are parallel to the shorter edges of the camera module 100 (i.e., the third side iii and fourth side iv).

Referring back to FIG. 4, the optical tube unit 140 may include at least one lens 141. The optical tube 140 may be disposed on an upper portion of the substrate 110. The optical tube 140 may be installed eccentrically with respect to a center or a central region of the substrate 110 to correspond to the photodetector 120. Further, the optical tube 140 may allow an image of an external object to enter into the photodetector 120. The photodetector 120 may have at least one lens 141 that may be movable in various directions, such as up or down. Further, the photodetector 120 may enable the control of a focal distance of the object or enable a clearer image of the object to enter into the photodetector 120.

Moreover, an outer surface of the lens 141 in the optical tube 140 may be coated with an infrared (IR) cut filtering layer to filter out infrared light. A lower portion of the optical tube 140 may have a space in which the substrate 110 may be accommodated. An outer surface of the optical tube 140 may be made of, for example, plastic, or other suitable materials.

The camera module 100 may employ a complementary metal oxide semiconductor (COMS) or a charge-coupled device (CCD).

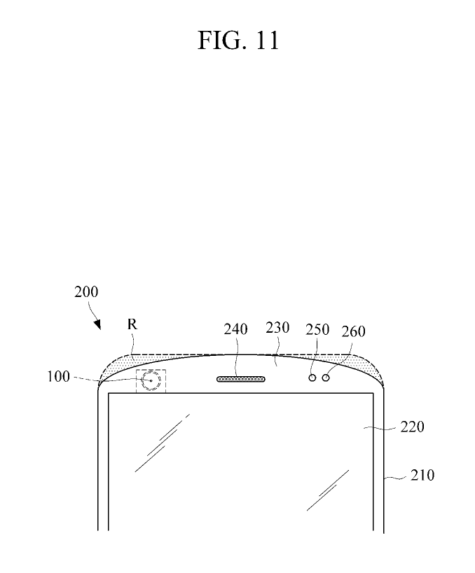

Referring to FIG. 9, an optical tube 140 of a camera module 100A is placed eccentrically with respect to a center or a central region of a substrate 110, unlike the camera module 100 shown in FIG. 8, which itself may be positioned eccentrically with respect to the center or central region of the substrate 110. When the camera module 100A shown in FIG. 9 is installed in a mobile communication terminal, the optical tube 140 may be disposed on or is connected to a bezel unit, such as a bezel unit 230 of FIG. 11, and other components of the camera module 110A may be disposed within a proximity of a display unit, such as a display unit 220 of FIG. 11, or on a lower portion of the display unit 220. For example, if there is a rectangular substrate 110 provided, as shown in FIG. 9, the substrate 110 may be disposed in such a manner that its longer or first edges L1 are arranged in a longitudinal direction of the bezel unit 230 to reduce the width of the bezel unit 230.

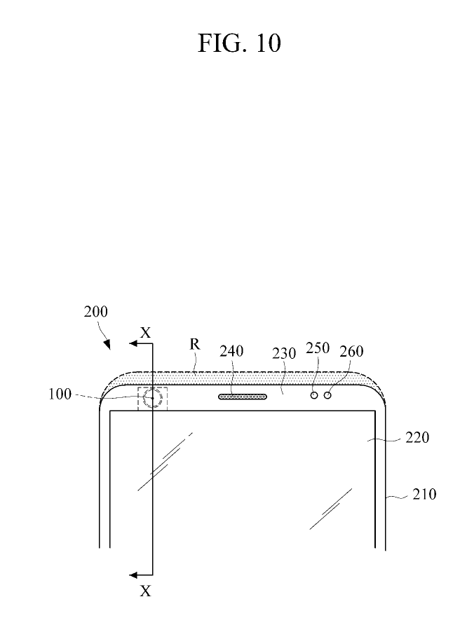

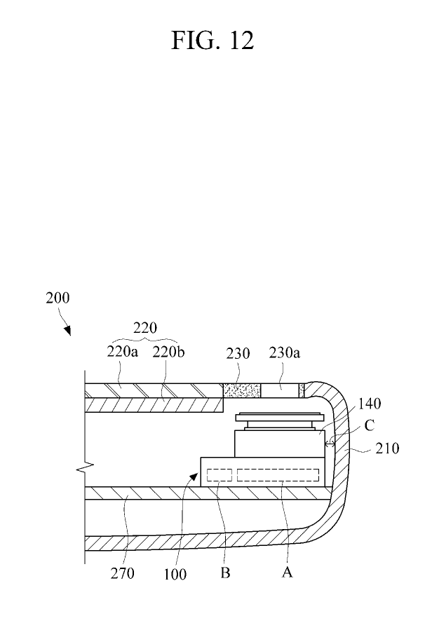

FIG. 10 and FIG. 11 are front views illustrating mobile communication terminals equipped with a camera module according to an exemplary embodiment of the present invention. FIG. 12 is a cross-sectional view of the mobile communication terminal taken along line X-X of FIG. 10.

Referring to FIG. 10, the mobile communication terminal 200 includes a body unit 210, a display unit 220, and a bezel unit 230. According to aspects of the invention, an area of the bezel unit 230 may be reduced in size.

Components constituting the mobile communication terminal 200 are placed inside the body unit 210. At a rear portion of the body unit 210, a battery may be placed to supply power to the mobile communication terminal 200. According to aspects of the invention, the body unit 210 may include an exterior casing for the mobile communication terminal 200, which may be composed of plastic, metals, or other materials.

The display unit 220 is placed in a front face of the body unit 210 to output images. A user may check an operating status of the mobile communication terminal 200 or view a video via the display unit 220. The display unit 220 may include a touch sensor 220a and a flat panel 220b, or include only the flat panel 220b.

The bezel unit 230 may be disposed around the display unit 220. A lower portion is of the bezel unit 230 may include at least one of a speaker unit 240, a proximity sensor unit 260, and an illuminance sensor unit 250. At least one of a portion 230a of the bezel unit 230, which may surround the speaker unit 240, the proximity sensor unit 260, and the illuminance sensor unit 250, may be made of a transparent material. According to aspects of the invention, the bezel unit 230 may extend from the body unit 210 to provide protective covering for the internal components of the mobile communication terminal 200. More specifically, the bezel unit 230 may house the speaker unit 240, the proximity sensor unit 260 and the illuminance sensor unit 250. Further, the bezel unit 230 may protect circumferential edges of the display unit 220.

The speaker unit 240 may include at least a speaker and a microphone to transmit and receive audio signals. The proximity sensor unit 260 may detect a presence of nearby objects with or without physical contact. The proximity sensor unit 260 may emit an electromagnetic field or a beam of electromagnetic radiation (e.g., infrared) and looks for changes in the field or return signal. The illuminance sensor unit 250 may measure the amount of light that may be available from various light emitting sources (e.g., sun, incandescent lamps, and fluorescent lamps). The illuminance sensor unit 250 may be used to determine a proper light exposure when capturing an image with the camera unit 100.

Referring to FIG. 12, the above-described camera module 100 may be mounted inside the body unit 210. The camera module 100 may be disposed such that the first region A of the substrate 110 may be arranged underneath the bezel unit 230 to allow the optical tube 140 to be exposed from the front face of the body unit 210 and the second region B may be arranged under the display unit 220. Accordingly, even when a high-resolution camera module with 1.3 or more megapixels is mounted on the body unit 210 of the mobile communication terminal 200 having the above-described configuration, a distance C between the circumferential surface of is the optical tube 140 of the camera module 100 and the body unit 210 may be reduced. More specifically, the distance C may be reduced because the photodetector 120 and the optical tube 140 are arranged eccentrically with respect to a center or a central region of the substrate 110 in the camera module 100. Accordingly, as shown in FIG. 10, the mobile communication terminal 200 may have the bezel unit 230, which may be reduced in size by area R.

In addition, it may be possible to reduce the areas of only side portions, such as right and left portions, of the bezel unit 230 as shown in FIG. 11, such that the bezel unit 230 is shaped as an arc. Accordingly, it may be possible to improve the aesthetic design of the mobile communication terminal 200 or allow more design capabilities. Area R, which may be illustrated as a shaded region surrounded by dashed lines may denote an area that is reduced from the bezel unit 230 in the mobile communication terminal 200.

Since the speaker unit 240 is placed in the middle or a middle region of the bezel unit 230 of the mobile communication terminal 200, the camera module 100 may be disposed in a side portion, such as the right side or the left side, of the bezel unit 230. However, aspects of the invention are not limited thereto, such that the speaker unit 240, and the camera module 100 may be disposed at various locations on the mobile communication terminal 200.

As described above, because the area of the bezel unit 230 may be reduced in the mobile communication terminal 200, it may be possible to manufacture the mobile to communication terminal 200 having a 1.3 or more megapixel high-resolution camera module 100 without increasing the size of the bezel unit 230 or its overall size.

According to the above exemplary embodiments of the present invention, even when a high resolution camera module, such as a 1.3 or more megapixel camera module, is installed in the body unit of the mobile communication terminal, it may be possible to reduce a is space under the bezel unit occupied by the camera module by reducing the area of the substrate protruding around the optical tube. The space under the bezel unit may be reduced by placing the photodetector and the optical tube in the camera module eccentrically with respect to a center or a central region of the substrate. More specifically, since the area of the bezel area may be reduced even with the addition of a camera module, the mobile communication terminal may be manufactured to have a high-resolution camera module without a large increase or any increase in size.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A camera module, comprising:
an optical tube comprising a lens;
a photodetector disposed on a first portion of a substrate; and
a plurality of capacitors disposed on a second portion of the substrate,
wherein the lens overlaps only the first portion of the substrate among the first portion and the second portion of the substrate.

2. The camera module of claim 1, wherein the photodetector is connected to the substrate by wire bonding.

3. The camera module of claim 1, wherein three of the four sides of the photodetector are connected to the substrate by wire bonding.

4. The camera module of claim 3, wherein the lens is disposed to extend beyond the side without the wire bonding.

5. The camera module of claim 1, wherein two of the four sides of the photodetector are connected to the substrate by wire bonding.

6. The camera module of claim 5, wherein the lens is disposed to extend beyond one of the two sides without the wire bonding.

7. A terminal, comprising:
a camera module, comprising:
an optical tube comprising a lens,
a photodetector disposed on a first portion of a substrate, and
a plurality of capacitors disposed on a second portion of the substrate;
a bezel unit to overlap the first portion of the substrate; and
a display unit to overlap the second portion of the substrate.

8. The terminal of claim 7, wherein the lens overlaps only the first portion of the substrate among the first portion and the second portion of the substrate.

9. The terminal of claim 7, wherein the bezel unit comprises a transparent portion.

10. The terminal of claim 7, wherein the first portion of the substrate is disposed towards an edge portion of the terminal.

11. The terminal of claim 7, wherein the photodetector is connected to the substrate by wire bonding.

12. The terminal of claim 7, wherein three of the four sides of the photodetector are connected to the substrate by wire bonding.

13. The terminal of claim 12, wherein the side of the photodetector not connected by the wire bonding is disposed to face an edge portion of the terminal.

14. A camera module in a mobile terminal, comprising:
an optical tube comprising a lens;
a photodetector disposed on a first portion of a substrate; and
a plurality of capacitors disposed on a second portion of the substrate;
a bezel unit to overlap a portion of the camera module,
wherein the lens overlaps only the first portion of the substrate among the first portion and the second portion of the substrate, and the first portion of the substrate is disposed towards an edge portion of the mobile terminal.

15. The camera module of claim 14, wherein the bezel unit comprises a transparent portion.

16. The camera module of claim 14, wherein the photodetector is connected to the substrate by wire bonding.

17. The camera module of claim 14, wherein three of the four sides of the photodetector are connected to the substrate are connected by wire bonding.

18. The camera module of claim 17, wherein the side of the photodetector not connected by the wire bonding is disposed to face an edge portion of the mobile terminal.

19. A camera module, comprising:
an optical tube comprising a lens;
a photodetector disposed on a first portion of a substrate; and
a capacitor disposed on a second portion of the substrate,
wherein the lens is disposed to extend beyond one of the edges of the photodetector.

20. The camera module of claim 19, wherein the lens extends towards an edge portion of a mobile terminal housing the camera module.
